(19) United States
(12) Patent Application Publication
(10) Pub. No.: US 2020/0226853 A1
(43) Pub. Date: Jul. 16, 2020

(54) AUTOMATED ACCIDENT LOGGING AND REPORTING

(71) Applicant: Toyota Motor North America, Inc., Plano, TX (US)

(72) Inventors: Hazem Ahmed, Plano, TX (US); Gunnar R. Heinisch, McKinney, TX (US)

(21) Appl. No.: 16/246,335

(22) Filed: Jan. 11, 2019

(51) Int. Cl. G07C 5/00; G07C 5/08; H04L 9/06

(52) U.S. Cl. CPC G07C 5/008; G07C 5/0816; H04L 2209/38; H04L 9/0618; G07C 5/0841

(57) ABSTRACT

Methods, systems, and devices of an accident logging and reporting system. The system includes multiple computing devices including a first computing device and a second computing device. Each computing device is configured to maintain a distributed ledger. The first computing device includes one or more sensors. The one or more sensors are configured to detect, measure and obtain sensor information related to an accident. The first computing device includes a communication unit that is configured to communicate with the second computing device. The first computing device includes an electronic control unit. The electronic control unit is configured to integrate a first set of accident information with a second set of accident information. The electronic control unit is configured to link a record that represents a combined set of accident information that incorporates the integrated first set and second set of accident information to the distributed ledger.

### BACKGROUND

### 1. Field

The present disclosure relates to systems, apparatuses, devices and methods for automatically logging and recording an accident using a blockchain.

### 2. Description of the Related Art

When an accident occurs, e.g., a vehicle collision, the accident may involve multiple parties. The multiple parties may include multiple drivers of different vehicles, different agencies, such as the police department, vehicle repair facilities, or insurance companies, and/or other agencies, such as the transportation agency that runs the traffic infrastructure. Each party may have a different perspective, view or understanding of the accident. Moreover, each perspective is only a single account of the accident from the perspective of that party. Other parties may have different accounts of the accident, and as a time passes, the recollection of the parties becomes less accurate. Traditional accident logging systems record data from the perspective of a single actor and do not necessarily account for the data acquired by other actors. The recorded data of a single actor only shows a snapshot of the accident and not necessarily all the circumstances surrounding the accident.

Moreover, traditional accident logging systems do not allow for other parties to proactively identify the accident, the circumstances surrounding the accident or other actions to take because of the accident, and so as time passes, the recollection of the parties involved in the accident may fade and the data reported to other parties may be less accurate.

Accordingly, there is a need for a system, apparatus and/or method to accurately and immutably collaborate, integrate, log and report an accident.

### SUMMARY

In general, one aspect of the subject matter described in this specification is embodied in an accident logging and reporting system (“accident reporting system”). The accident reporting system includes multiple computing devices. The multiple computing devices include a first computing device and a second computing device. The first computing device is integrated within a first vehicle. Each computing device is configured to maintain a distributed ledger. The first computing device includes one or more sensors. The one or more sensors are configured to detect, measure and/or obtain sensor information related to an accident. The first computing device includes a communication unit. The communication unit is configured to communicate with the second computing device. The first computing device includes an electronic control unit coupled to the one or more sensors and the communication unit. The electronic control unit is configured to integrate a first set of accident information with a second set of accident information generated by the second computing device. The electronic control unit is configured to link a record that represents a combined set of accident information that incorporates the integrated first set and second set of accident information to the distributed ledger.

These and other embodiments may optionally include one or more of the following features. The distributed ledger may be represented by a blockchain that may be formed from multiple blocks. The record may be associated with a block. The electronic control unit may be configured to obtain a third set of accident information. The electronic control unit may be configured to compare each parameter of the first set of accident information with a corresponding parameter of the second set of accident information and the third set of accident information. The electronic control unit may be configured to determine whether the parameter of the first set of accident information matches (or is very similar to) the corresponding parameter of the second set of accident information or the third set of accident information. The electronic control unit may be configured to form the combined set of accident information from the parameters that match among the first set of accident information, the second set of accident information and the third set of accident information. The one or more sensors may include a vehicle speed sensor, an impact sensor, or a camera. The vehicle speed sensor may be configured to measure a speed of the first vehicle, the impact sensor may be configured to detect a collision, and the camera may be configured to capture image data.

The second computing device may be a traffic database or traffic infrastructure. The traffic database or traffic infrastructure may be configured to provide traffic information including a state of one or more traffic signals. The second set of accident information may include the state of the one or more traffic signals. The state may indicate a right of way of traffic, a color of the traffic signal, an arrow of the traffic signal, etc. The electronic control unit may be configured to associate the record with a vehicle identification number and an accident scene identifier. The accident scene identifier may include a timestamp of a time of the accident and a location of the accident.

The one or more sensors may include a battery sensor. The electronic control unit may be configured to determine, using the battery sensor, that a battery is damaged. The electronic control unit may be configured to include information that indicates that the battery is damaged in the first set of information. The electronic control unit may be configured to associate the combined set of accident information with a vehicle identification number of the first vehicle.

The second computing device may be associated with a repair service provider. The second computing device may include a processor. The processor may be configured to read and/or obtain the record based on at least one of the accident scene identifier or the vehicle identification number. The processor may be configured to determine that the record is incomplete or inaccurate. The processor may be configured to associate a new record that has additional accident information with the accident scene identifier. The processor may be configured to provide the new record to a consumer or link the new record to the distributed ledger using the accident scene identifier.

In another aspect, the subject matter is embodied in a method for accident logging and reporting. The method includes detecting, by a first sensor of a first vehicle, that a collision has occurred to the first vehicle. The method includes generating, by a processor of the first vehicle, a first set of accident information related to the collision of the first vehicle. The method includes coordinating, by the processor of the first vehicle, the first set of accident information with a second set of accident information. The method includes linking, by the processor of the first vehicle, a block that represents a combined set of accident information that is based on the first set of accident information and the second set of accident information to a plurality of blocks of a distributed ledger.

In another aspect, the subject matter is embodied in a system. The system includes multiple computing devices. The multiple computing devices include a first computing device integrated on a first vehicle and a second computing device integrated on a second vehicle. Each computing device is configured to maintain a distributed ledger formed from multiple blocks. The first computing device includes a first sensor that is configured to detect a collision of the first vehicle. The first computing device includes an electronic control unit coupled to the first sensor. The electronic control unit is configured to obtain a first set of accident information when the first sensor detects a collision. The electronic control unit is configured to integrate the first set of accident information with a second set of accident information generated by the second computing device and link a block that represents a combined set of accident information that incorporates the integrated first set and second set of accident information to the plurality of blocks that form the distributed ledger.

### BRIEF DESCRIPTION OF THE DRAWINGS

Other systems, methods, features, and advantages of the present invention will be or will become apparent to one of ordinary skill in the art upon examination of the following figures and detailed description. It is intended that all such additional systems, methods, features, and advantages be included within this description, be within the scope of the present invention, and be protected by the accompanying claims. Component parts shown in the drawings are not necessarily to scale and may be exaggerated to better illustrate the important features of the present invention. In the drawings, like reference numerals designate like parts throughout the different views.

FIG. 1 is a block diagram of an example accident reporting system that uses a distributed ledger to log and report accident information according to an aspect of the invention.

FIG. 2 is a block diagram of an example computing device of the accident reporting system of FIG. 1 according to an aspect of the invention.

FIG. 3 is a block diagram of an example vehicle entity of the accident reporting system of FIG. 1 according to an aspect of the invention.

FIG. 4 is a flow diagram of an example process for reporting an accident to one or more distributed ledgers using the accident reporting system of FIG. 1 according to an aspect of the invention.

FIG. 5 is a flow diagram of an example process for adding a new record that modifies or adds to an existing record and reporting the new record and/or existing record to an entity with or without access to the one or more distributed ledgers to perform one or more actions using the accident reporting system of FIG. 1 according to an aspect of the invention.

FIG. 6 is a block diagram of an example blockchain that represented a distributed ledger used by the accident reporting system of FIG. 1 according to an aspect of the invention.

### DETAILED DESCRIPTION

Disclosed herein are systems, devices, apparatuses and methods for accurately and immutably logging and reporting accident information to multiple entities. In some instances, an actor may be both a consumer and a provider of accident information. The accident logging and reporting system (“accident reporting system”) obtains, collects and analyzes sensor information, accident information and other information from disparate sources and/or actors. The accident reporting system may form a multi-perspective view of the accident that accounts for the different perspectives from the different entities and stores the multi-perspective view of the accident on a record of a distributed ledger. This allows the accident reporting system to form a more accurate initial representation of the accident.

Moreover, by storing the multi-perspective view of the accident on the distributed ledger, other entities may verify, authenticate and/or otherwise verify the accuracy of the record. Other actors may append additional information that modifies, updates and/or otherwise presents differences to the initial representation. For example, an actor may update the status of injuries of any passengers or drivers involved in the accident, which allows insurance companies to estimate costs, damages and other residual costs in real-time. Thus, the accident reporting system allows for the accident information to be updated so that the representation accurately reflects the accident.

Other benefits and advantages include the capability to view, analyze and report the accident information including any damage sustained to various actors based on the accident information. This allows various actors to proactively reach out to actors involved in the accident to provide the actors with services, products or other information in real-time or near real-time and preserves the accuracy of the accident information.

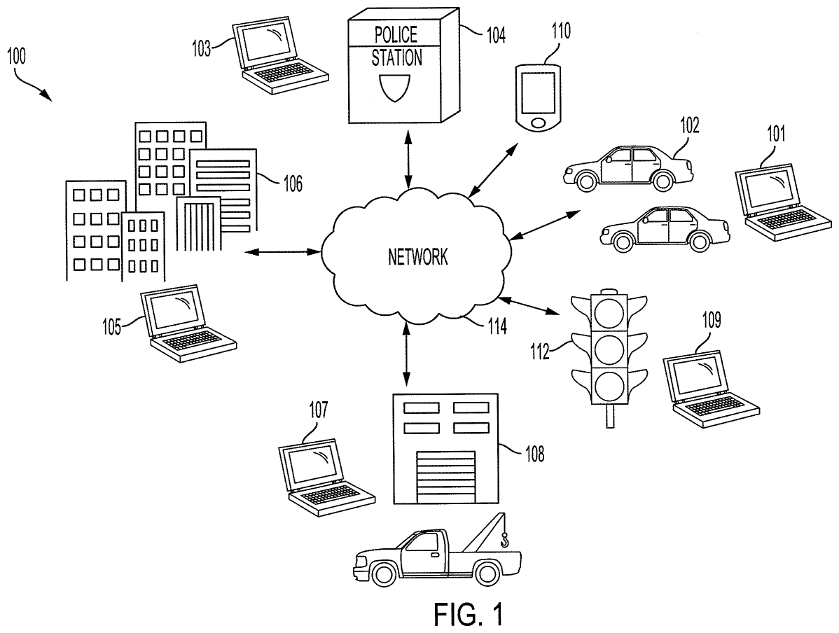

FIG. 1 is a block diagram showing the accident logging and reporting system (“accident reporting system”) 100 having one or more distributed ledgers (e.g., blockchains) implemented as multiple computing apparatuses (or “computing devices”) 101, 103, 105, 107, 109 associated with various entities, such as one or more vehicle entities (or “vehicle”) 102, one or more public entities 104, one or more private reporting entities 106, one or more service provider entities 108 and/or one or more traffic infrastructure entities 112. A distributed ledger may be represented on a blockchain. The use of storing a record on a distributed ledger allows for other entities to check, verify, and/or validate the record placed on the distributed ledger. Moreover, the distributed ledger functions as an immutable record of the recorded information. The immutable record prevents others from tampering with, modifying or deleting any of the records on the distributed ledger.

Other entities, such as one or more private users using a smartphone 110 or wearable device, may also be included, added, and/or removed from the one or more distributed ledgers. The various entities may each store, view or add one or more records to the one or more distributed ledgers using computing devices 101, 103, 105, 107, 109 having one or more data processing apparatuses, such as a processor. Since the one or more distributed ledgers utilize multiple computing devices 101, 103, 105, 107, 109, 110, the one or more distributed ledgers may store a significant amount of data that may or may not be encrypted.

The computing devices 101, 103, 105, 107, 109 of the various entities may be represented as a node within the blockchain topology and each addition of information to the distributed ledger may be represented as a block. The various entities may add to the one or more distributed ledgers to update the one or more distributed ledgers with any updates or modifications. These entities may view, obtain, and/or add to the one or more distributed ledgers to receive or provide real-time accurate information from or to the other entities.

The one or more public entities 104 may include various government agencies, such as the police, fire services and/or other city services, and/or hybrid public-private agencies, such as hospital services and/or ambulance services. The one or more public entities 104 may utilize a computing device 103. In one example, when another entity, such as the vehicle 102, adds a record to the distributed ledger that describes an accident, the police may review the information within the block that describes the accident and deploy resources to the accident scene. Subsequently, the police may add another record to the distributed ledger that describes the police report including any witness statements, accident scene investigation information or other additional tation related to the accident to the distributed ledger. In another example, a hospital near the accident scene may read the police report and/or the record that describes the accident, and in response, anticipate that injured persons would be sent to the hospital. The hospital may prepare doctors, nurses or other health professionals and/or equipment or other facilities to receive the injured persons and place or store a record to the distributed ledger that indicates that the hospital is ready to receive the injured persons and the resources that are on standby.

The one or more private reporting entities 106 may include one or more private insurance companies, such as an auto insurance company, a health insurance company, a life insurance company or other liability insurance company. The one or more private reporting entities 106 may utilize a computing device 105. In one example, an auto insurance company may use the records regarding the accident and the police report to automatically prepare a claim for an owner of a vehicle involved in the accident or may automatically call a tow truck provider to deploy a tow truck to the accident scene. In another example, a health or life insurance company may automatically prepare a claim or evaluate health care costs of an injured or deceased person. The auto, health or life insurance company may add the record of the claim to the distributed ledge for future reference and/or to notify the claimant and/or claim recipient.

The one or more service provider entities 108 may include a dealership, a tow truck service, a collision center or other repair shop. The one or more service provider entities 108 may utilize a computing apparatus 107. In one example, the collision center may review records regarding the accident. The record may include information regarding the damage to the vehicle. The collision center may provide an estimate or a quote based on the record that includes information regarding the damage to the vehicle. The collision center may send the estimate or the quote directly to an owner of the vehicle or append a record to the distributed ledger with the estimate so that the owner may review and compare the estimate with other estimates on the distributed ledger. In another example, the tow truck service company may review the record and deploy a tow truck based on the record.

The one or more traffic infrastructure entities 112 may include one or more traffic signals, one or more sensors including one or more cameras, vehicle speed sensors or traffic sensors, and/or other traffic infrastructure. The one or more traffic infrastructure entities 112 may utilize a computing device 109. In one example, the camera or other sensor may detect that an accident has occurred. The one or more traffic signals closest in proximity to the accident may record the state of the traffic signal, e.g., whether the traffic signal was green, red, yellow, flashing red, operable, inoperable, or other signal indicator such as an arrow, on a block to place on the distributed ledger and to share with the one or more other entities.

The one or more other entities, such as the one or more private users 100, may be a family member or a friend. In one example, a family member or a friend on their mobile device or smart phone may view the distributed ledger and be notified of an accident involving a family member or a friend. The family member or the friend may be able to view the location of the accident and/or the hospital that a party of the accident has been transported too. Another example of the one or more private users 100 may be a buyer of a vehicle 102. The one or more private users 100 may review the one or more distributed ledgers and search for a specific vehicle using an identifier, such as a vehicle identification number. The one or more private user 100 may identify one or more records within the one or more distributed ledgers associated with the identifier and use the records to determine that an accident has occurred in the past and the accident history of the vehicle 102 and/or the damage that has occurred to the vehicle 102, e.g., specific parts that were damaged to the vehicle 102 in an accident or a collision and/or the portions of the vehicle 102 that were damaged and/or repaired. Another private user 100 may be a virtual assistant, where the virtual assistant can identify if the driver or passengers will have to cancel or reschedule certain activities due to the accident and notify appropriate other parties of such cancellation.

The one or more vehicle entities 102 may include one or more vehicles including a vehicle 102 and/or multiple vehicles. The one or more vehicle entities 102 may utilize a computing apparatus 101 such as a controller, an electronic control unit, or a processor. In one example, the vehicle 102 may provide a record of the accident to the distributed ledger to share with the other entities. The record may be a corroborated record between multiple vehicles involved in the accident and/or a single account of the accident from the vehicle 102. The record may include other information corroborated and/or aggregated from other entities or infrastructure, such as a traffic signal or one or more cameras positioned near the accident or intersection.

A vehicle 102 is a conveyance capable of transporting a person, an object, or a permanently or temporarily affixed apparatus. The vehicle 102 may be a self-propelled wheeled conveyance, such as a car, a sports utility vehicle, a truck, a bus, a van or other motor or battery driven or fuel cell driven vehicle. For example, the vehicle 102 may be an electric vehicle, a hybrid vehicle, a hydrogen fuel cell vehicle, a plug-in hybrid vehicle or any other type of vehicle that has a fuel cell stack, a motor and/or a generator 316. Other examples of vehicles include bicycles, trains, planes, or boats, and any other form of conveyance that is capable of transportation. The vehicle 102 may be semi-autonomous or autonomous. That is, the vehicle 102 may be self-maneuvering and navigate without human input. An autonomous vehicle may have and use one or more sensors 308 and/or a navigation unit 324 to drive autonomously.

The accident reporting system 100 maintains the one or more distributed ledgers using the one or more computing devices for each of the multiple entities. The computing device may be included within, embedded within, retrofitted to or otherwise connected or coupled to the one or more entities. The accident reporting system 100 includes computing devices integrated, included, retro-fitted or otherwise connected or coupled to the vehicle 102.

The computing devices 101, 103, 105, 107, 109, 110 of the accident reporting system 100 collects, aggregate, analyze and/or perform reporting of accident information for the vehicle 102. The computing devices 101, 103, 105, 107, 109 obtain various types of information, such as vehicle information, traffic information, road condition information and/or weather information, from various disparate and independent sources, to form a complete record of the accident on the distributed ledger for review by other entities. The accident reporting system 100 may be useful in creating a record of an accident involving any type of vehicle including, but not limited to, semi-autonomous vehicles, autonomous vehicle, hybrid or plug-in hybrid vehicles, electric vehicles, fuel cell vehicles or any other form of conveyance.

Vehicle information may include one or more locations associated with the vehicle 102, such as a location of an accident with the vehicle 102, a start location of the vehicle 102, a current location of the vehicle 102 or a destination of the vehicle 102. The vehicle information may include a speed of the vehicle 102, prior to, at and/or after the impact of the vehicle 102 with another object. Other vehicle information may include change in speed, an angle of the steering wheel, direction of travel of the vehicle 102, braking data including an applied pressure to the brake, acceleration data including an applied pressure to the accelerator and/or other data related to the vehicle 102, such as a state of charge of the battery of the vehicle 102, tire pressure, other maintenance conditions of the vehicle 102 and/or other factors that affect the drivability or condition of the vehicle 102. Vehicle information may include driver information. The driver information includes a condition of the driver, such as the drowsiness, sleepiness, blood pressure glucose level or other condition of the driver. Further, in some embodiments, such sensed driver conditions before and after the accident may be added to the record and transmitted to first responders to allow for appropriate personnel and equipment to be brought to the accident scene automatically based on the record. Vehicle information may include any information available on the vehicle 102 CAN bus including sensors to the battery, fuel cell, engine, vehicles speed sensors or steering wheel sensors and/or other sensors.

Traffic information may include the relative location of one or more other vehicles surrounding the vehicle 102 prior to, at or after the impact of the vehicle 102 with the one or more other vehicles. The traffic information may include the relative speed, change in speed, such as the deceleration or acceleration of the other vehicle, and direction of travel of the one or more other vehicles relative to the vehicle 102 along with the relative distance of the one or more other vehicles with the vehicle 102. Other traffic information may include the traffic density or speed of traffic surrounding the vehicle 102 at, prior to or after the impact of the vehicle 102 with another object.

Weather information may include the weather at the location of the accident or the location of the vehicle 102. The weather may include the position of the sun or the amount of light, the amount of precipitation, the temperature, the humidity, the speed and/or the direction of the wind and/or any other factors that may influence drivability of the vehicle 102 and/or one or more of the surrounding vehicles.

Road condition information may include the condition of the road, such as the amount of precipitation on the roadway that the vehicle 102 is travelling. Road condition information may include other factors including the type of the road, such as local road, highway, freeway, and/or dirt road, the location of any construction on the roadway and/or any hazards on the roadway, such as a speedbump or a pothole, which may influence drivability of the vehicle 102 and/or one or more of the surrounding vehicles.

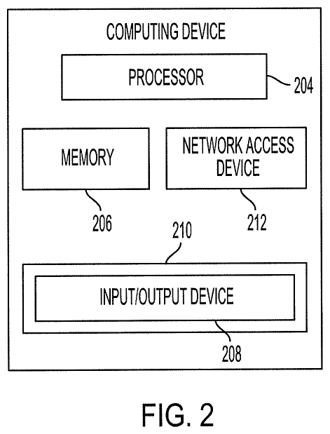

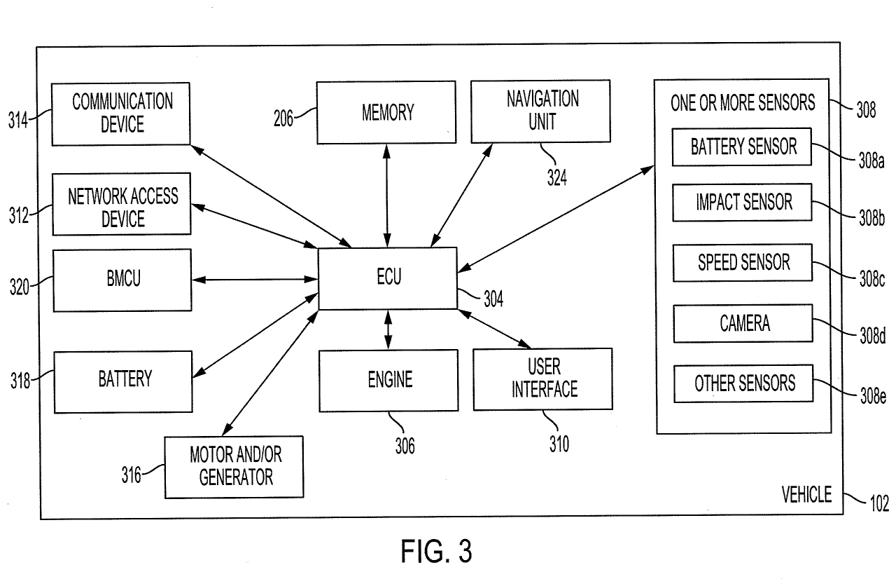

FIG. 2 is a block diagram of the one or more computing devices 101, 103, 105, 107, 109 and/or the smartphone 110 (hereinafter referred to as “computing devices”). The computing devices 101, 103, 105, 107, 109, 110 include a processor 204, such as an electronic control unit (ECU) 304, and a memory 206. The computing devices 101, 103, 105, 107, 109, 110 may include a user interface 210, one or more sensors 308, a communication device 314 and/or a network access device 212, and may be retrofitted, included within or otherwise connected or coupled to a corresponding entity that provides other components. For example, the computing device 101 may be connected to the vehicle 102. The vehicle 102 may include one or more other components, such as an engine 306, a motor and/or generator 316, a battery 318, a battery management and control unit (BMCU) 320 and/or a navigation unit 324, as shown in FIG. 3, for example.

The computing devices 101, 103, 105, 107, 109, 110 include one or more processors 204, such as an electronic control unit (ECU) 304. The one or more processors 204 or the ECU 304 may be implemented as a single processor or ECU or as multiple processors or ECUs, respectively. The ECU 304 may be electrically coupled to some or all of the components of the vehicle 102. The one or more processors 204 or controllers are designed for interacting with the distributed ledger, such as reading, viewing, and/or adding a block to the blockchain, and/or obtaining data from the one or more sensors 308. The ECU 304 may interact with the other ECUs of other surrounding vehicles and form an accident report. The accident report may indicate damage to the vehicle 102 as well as provide accident information describing the accident, such as the speed and/or the direction of the vehicle 102 and the other surrounding vehicles. The one or more processors 204 may provide additional accident information, determine cost estimates or damage and/or report injuries to one or more entities.

The memory 206 may be coupled to the one or more processors 204 or the ECU 304 and store instructions that the one or more processors 204 or the ECU 304 executes, respectively. The memory 206 may include one or more of a Random Access Memory (RAM) or other volatile or non-volatile memory. The memory 206 may be a non-transitory memory or a data storage device, such as a hard disk drive, a solid-state disk drive, a hybrid disk drive, or other appropriate data storage, and may further store machine-readable instructions, which may be loaded and executed by the one or more processors 204 or ECUs 304.

The computing devices 101, 103, 105, 107, 109, 110 may include a user interface 210. The user interface 210 may include an input/output device 208 capable of receiving user input, such as a user interface element, a button, a dial, a microphone, a keyboard, or a touch screen, and any device capable of output, such as a display, a speaker, or a refreshable braille display. The user interface 210 may display one or more notifications or a record associated with the distributed ledger. The record may have accident information, a quote or an order, for example. The user interface 210 may receive user input that may include additional accident information. The additional accident information may include repair information or any additional analysis by a technician, an officer, a witness, a claims adjuster, an underwriter or other persons. For example, a repair technician at a service provide entity, such as a repair shop, may provide the information on the parts that need to be ordered and/or the labor that is needed to form a record to be placed on the distributed ledger.

The computing devices 101, 103, 105, 107, 109, 110 may include a network access device 212. The network access device 212 may include a communication port or channel, such as one or more of a Wi-Fi unit, a Bluetooth® unit, a radio frequency identification (RFID) tag or reader, or a cellular network unit for accessing a cellular network (such as 3G, 4G or 5G). The network access device 212 may transmit data to and receive data from devices and systems not directly connected to the computing devices 101, 103, 105, 107, 109, 110 via a network 114. The network 114, such as a local area network (LAN), a wide area network (WAN), a cellular network, the Internet, or combination thereof, various computing devices of the multiple entities. One or more of the computing devices 101, 103, 105, 107, 109, 110 may be integrated within an entity, such as the computing device 101, which may be retro-fitted, integrated, included or otherwise connected or coupled to the vehicle 102. The various computing devices 101, 103, 105, 107, 109, 110 store the accident record information, e.g., within a distributed ledger, such as using a blockchain.

FIG. 3 shows a block diagram of the computing device 101 within the vehicle 102. The computing device 101 may include or be coupled to one or more other components. The one or more other components may be part of the vehicle 102. The one or more other components may include one or more sensors 308, a communication device 314 and/or a navigation unit 324.

The one or more sensors 308 may include a battery sensor 308a, an impact sensor 308b, a speed sensor 308c, a camera 308d and/or other sensors 308e. The battery sensor 308a may monitor the state of charge of the battery 318 and/or may monitor the health or condition of the battery 318, for example. The battery sensor 308a may detect that the battery 318 is damaged, inoperable or otherwise not operating properly, and may detect the severity of the damage. In some cases, an accident that causes damage to the battery system detected by the battery sensor 308a causes the information to be added to the record where the record is shared with appropriate first responders, where such first responders may request appropriate fire, medical, and hazardous materials, personnel or equipment be brought to the accident scene automatically based on the record. In another example, the impact sensor 308b may measure or detect an impact or a collision with the vehicle 102. The impact sensor 308b may be positioned along the bumper, the frame or on the exterior of the vehicle 102.

The one or more other sensors 308e may include an accelerator or brake pedal sensor that measures the pressure applied to the accelerator pedal or the brake pedal, respectively. The other sensors 308e may include a steering wheel sensor that measures the angle of the steering wheel or a drowsiness detection sensor that measure the drowsiness of the driver of the vehicle 102. In some implementations, the one or more other sensors 308e may include a proximity sensor, a radar or a LIDAR device that determines presence of and measures distance to an object, such as another surrounding vehicle. Such measurement information may be measured individually by the sensors or in combination with other sensors, including camera 308d, to determine presence and distance to an object.

The computing device 101 may include or be coupled to other examples of the one or more sensors 308. The other examples include a speed sensor 308c, and/or a camera 308d. The speed sensor 308c may measure a speed of the vehicle 102. For example, the speed sensor 308c may measure the revolutions per minute (RPMs) of the wheels of the vehicle 102 or may calculate the speed of the vehicle 102 based on a traveled distance between two locations over time. The camera 308d, on the other hand, may capture image data of the surrounding vehicles and/or environment. The image data may be captured over a period of time. A processor, such as the ECU 304, may analyze the image data to determine the relative speed and/or the relative direction of the surrounding vehicles. The processor may also analyze the image data to determine traffic density and/or recognize objects within a path of the vehicle 102 or the other surrounding vehicles.

In some implementations, the one or more sensors 308 may include a camera, a body sensor, a hand sensor or other sensor that monitors and/or determines conditions of the driver, such as the driver's sleepiness, blood pressure, heart rate, glucose level or other condition of the driver. The one or more sensors 308 may monitor the conditions of the driver directly, e.g., through a touch sensor, smartwatch and/or indirectly.

The computing device 101 may include or be coupled to a communication device 314. The communication device 314 may be an application that runs on the computing device 101 to communicate with a server or other remote device. The communication device 314 may use Vehicle-to-Vehicle (V2V) communication to communicate with one or more surrounding vehicles to corroborate accident information and/or use Vehicle-to-Infrastructure (V2I) communication to communicate with traffic infrastructure to integrate or obtain traffic and/or accident information. In some implementations, the computing device 101 may be coupled to a communication device 314, such as a smart phone or a mobile device of an occupant, to use the functions of the communication device 314, such as a global positioning satellite device, to obtain vehicle information, navigation information and/or weather information and/or to transmit a record to the distributed ledger.

The computing device 101 may be coupled to one or more vehicle components of the vehicle 102. The one or more vehicle components may include an engine 306, a motor and/or generator 316, a battery 218 and/or a battery management and control unit (BMCU) 320.

The motor and/or generator 316 may be an electric motor and an electric generator that converts electrical energy into mechanical power, such as torque, and converts mechanical power into electrical energy. The motor and/or generator 316 may be coupled to the battery 318. The motor and/or generator 316 may convert the energy from the battery 318 into mechanical power, and may provide energy back to the battery 318, for example, via regenerative braking. In some implementations, the vehicle 102 may include one or more additional power generation devices such as the engine 306 or a hydrogen fuel cell stack (not shown). The engine 306 combusts fuel to provide power instead of and/or in addition to the power supplied by the motor and/or generator 316. In an embodiment with a hydrogen fuel cell stack, hydrogen is processed by the stack to supply power to the motor and/or generator 316.

The battery 318 may be coupled to the motor and/or generator 316 and may provide electrical energy to and receive electrical energy from the motor and/or generator 316. The battery 318 may include one or more rechargeable batteries.

The battery management and control unit (BMCU) 320 may be coupled to the battery 318 and control and manage the charging and discharging of the battery 318. The BMCU 320, for example, may measure, using the battery sensor, parameters used to determine the state of charge (SOC) of the battery 318.

The one or more vehicle components may include a navigation unit 324 that obtains navigational map information and/or vehicle information to autonomously navigate the vehicle 102 and/or display a route to the user through the user interface 210. The navigational map information may include a map that identifies roadways, terrains and other points of interest to navigate the vehicle 102. The navigational map information may include route information that includes a starting point, a destination point and a path of travel from the starting point to the destination point for the vehicle 102. The vehicle information may include a current location of the vehicle 102, a current direction of travel of the vehicle 102 and/or a current speed of the vehicle 102. In an embodiment, the navigation unit 324 uses global positioning system (GPS) information to determine such information.

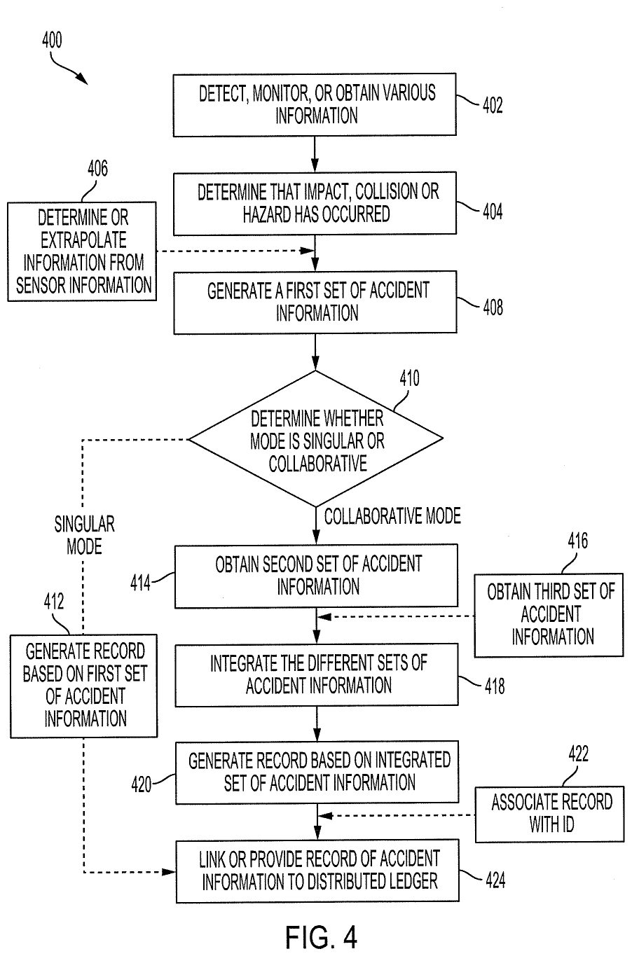

FIG. 4 is a flow diagram of a process 400 for reporting an accident to the one or more distributed ledgers. One or more computers or data processing apparatuses, for example, the ECU 304 of the computing device 101 of the accident reporting system 100 of FIG. 1, appropriately programmed, may implement and execute the process 400.

The accident reporting system 100 detects, monitors and/or obtains sensor information, vehicle information, traffic information, road condition information and/or weather infatuation (402). The accident reporting system 100 may use the one or more sensors 308 to detect, monitor and/or obtain the sensor information. The accident reporting system 100 may record the sensor information within a buffer that is within the memory 206 so that the sensor information may be continuously recorded in real-time and/or over a period of time, such as before, at and after an impact to the vehicle 102. In some implementations, the sensor information may be backed-up or stored in a remote server, computer or cloud device.

The sensor information may include image data from the camera 308d, the state of charge (SOC) and condition of the battery 318 from the battery sensor 308a, the vehicle information, such as the speed, from the speed sensor 308c, and/or an indication that the vehicle 102 has impacted another object or an amount of pressure that has been applied to a portion of the vehicle 102, from the impact sensor 308b. Other sensor information may include a distance or a relative distance between the vehicle 102 and/or an object or a surrounding vehicle.

For example, the impact sensor 308b may be positioned on a bumper of the vehicle 102 and detect and/or measure a pressure applied to the bumper. When the pressure exceeds a threshold amount, the impact sensor 308b may provide an indication that an impact or a collision has occurred. In some implementations, the impact sensor 308b may be positioned throughout the exterior of the vehicle 102 and may provide pressure readings of different portions of the vehicle 102. When an applied pressure exceeds a threshold pressure the exterior of the vehicle 102 is able to sustain, the impact sensor 308b may indicate a portion of the vehicle 102 that has been damaged and/or an impact has occurred.

In another example, the battery sensor 308a may detect an electrical short or a sudden loss of the state of charge, which may indicate that the battery 318 is damaged or that there is a hazard or a collision that has caused the damage. In another example, the one or more other sensors 308 may include a temperature sensor. The temperature sensor may measure, detect and/or obtain a temperature within the vehicle 102, such as a temperature of the fuel tank or the engine 306.

In another example, a fuel cell system damage sensor may detect damage to the fuel cell or hydrogen tank, which may indicate that the fuel cell is damaged or that there is a leak, short or other damage to the fuel cell or hydrogen tank. The detected damage may be determined and added to the accident information with the record, which may be used by first responders, such as the police or hospital.

In some implementations, the accident reporting system 100 may obtain other information, such as the vehicle information, the road condition information, the traffic information and/or the weather information, from other components, such as the navigation unit 324 or from a remote server or device via the network access device 312. The accident reporting system 100 may obtain vehicle information, such as the location, the speed and/or the direction of the vehicle 102, from a global positioning device that is part of the navigation unit 324. The accident reporting system 100 may calculate the speed and/or the direction based on the traversal from one location to another location over a period of time. In some implementations, the accident reporting system 100 may download weather information including any local precipitation, wind shear, sun glare or other factors that may influence drivability from a remote server. Other information, such as the road condition information and the traffic condition information, may be downloaded or obtained from the remote server or from one or more sensors. The accident reporting system 100 may provide the remote server with a current location of the vehicle 102 and receive the weather information, the traffic condition information and/or the road condition information from the remote server.

The accident reporting system 100 determines that an impact, a collision or a hazard has occurred (404). The accident reporting system 100 may determine that the impact, the collision or the hazard has occurred based on the sensor information. For example, the accident reporting system 100 may determine that the amount of pressure applied to a portion of the vehicle 102 is greater than or equal to a threshold amount. If the amount of pressure applied is greater than or equal to the threshold amount, the accident reporting system 100 may determine that an impact has occurred. In another example, the accident reporting system 100 may determine or obtain the temperature within the vehicle 102. If the temperature is greater than or equal to a threshold temperature, the accident reporting system 100 may determine that a hazard, such as a fire, has occurred.

In some implementations, the accident reporting system 100 may anticipate that an impact, a collision or a hazard is going to or about to occur. The accident reporting system 100 may use the camera 308d, the proximity sensor and/or the navigation unit 324 to determine that the vehicle 102 is about to collide or impact with another surrounding vehicle. For example, the proximity sensor may provide a relative distance to a surrounding vehicle or the ECU 304 may calculate a relative distance from the image data obtained from the camera 308d. If the relative distance is less than a threshold amount and is decreasing, the accident reporting system 100 may anticipate, predict and/or determine that a collision or an impact is about to occur.

The accident reporting system 100 may determine or extrapolate other information from the sensor information, the vehicle information, the traffic condition information, the road condition information and/or the weather information (406). The accident reporting system 100 may extract the image data from the sensor information and may compare time-lapsed images of the other surrounding vehicles taken over a period of time. By comparing the time-lapsed images, the accident reporting system 100 may determine the relative speed, the relative distance and/or the relative direction of the other surrounding vehicles.

In some implementations, the accident reporting system 100 may extrapolate and/or determine the damage that has occurred to the vehicle 102. For example, the accident reporting system 100 may analyze the reaction of the driver of the vehicle 102, the proximity and information related to the other surrounding vehicles, the pressure applied and the location of the pressure applied when the vehicle 102 collides with an object. The accident reporting system 100 may determine the amount of damage, the location of the damage and the cost of the damage resulting from the collision based on the analyzed data. Other examples of extrapolated information include a distance that the vehicle 102 skidded when the brake pedal was depressed based on the speed of the vehicle 102, the rate of depression of the brake pedal and/or the weather information, such as an amount of precipitation that has fallen on the road. The determined or extrapolated information may be used to form a more complete depiction of the accident scene from the perspective of the vehicle 102.

In another example, the computing device 101 associated with the vehicle 102 may use multiple inputs, such as from the battery sensor that may indicate any damage to the battery, one or more pressure sensors that may indicate damage to an exterior of the vehicle, the image data that the relative speed of the collision may be calculated from or other indications of a hazard or damage may be recognized and/or the temperature within the vehicle 102 from a temperature sensor. The accident reporting system 100 may apply the multiple inputs to a machine learning algorithm to determine and/or extrapolate the amount and the location of damage that may have been caused to the vehicle 102.

The accident reporting system 100 generates or forms a first set of accident information (408). The first set of accident information forms a record of the accident and the accident scene from the perspective of the vehicle 102 and may include the weather information, the road condition information, the sensor information and/or the vehicle information. The first set of accident information may include data before, during or after the impact of the vehicle 102. The data may have been buffered in the memory 206 or in the remote server, computer or cloud device, and obtained from the memory 206, the remote server, computer or cloud device, for example.

For example, the first set of accident information may log the temperature of one or more components of the vehicle 102, the speed and/or the direction of the vehicle 102, the relative speed and/or the direction of the surrounding vehicles, the rate of acceleration or deceleration of the vehicle 102 based on the applied pressure to the accelerator or the brake, respectively. Moreover, any damage to the vehicle 102, such as damage to the battery 318 or to the exterior of the vehicle 102, any unexpected depletion or short of the electrical systems may be included in the first set of accident information. In some implementations, the first set of accident information may include the weather information, such as the direction of the sun glare, and/or the road condition information including the amount of precipitation having fallen on the roadway at the location of the accident. In some implementations, the first set of accident information may include vehicle information, such as the conditions of the driver, before, after and during the accident to later provide in the record for an entity, such as a hospital, to identify any injuries resulting from the accident.

The accident reporting system 100 determines whether the mode is in a singular mode or a collaborative mode (410). The determination may be based on user input, a user configured or otherwise pre-determined setting of a mode. The mode may be pre-determined or pre-set for each of the different computing devices 101, 103, 105, 107, 109, 110. In some implementations, the accident reporting system 100 may have a default mode or receive user input that sets the mode for each of the different computing devices 101, 103, 105, 107, 109, 110.

In the collaborative mode, a computing device 101, 103, 105, 107, 109, 110, such as the computing device 101, interacts, aggregates, and/or corroborates with various other apparatuses or entities to verify and/or integrate the collected information to depict a multi-perspective analysis and view of the accident prior to providing the accident information to the distributed ledger. This forms a more complete initial record of the accident scene.

In the singular mode, a computing device 101, 103, 105, 107, 109, 110, such as the computing device 101, relies on information obtained directly, such as from one or more components including one or more sensors 308 directly coupled to or included within the computing device 101. When in the singular mode, the computing device 101 forms the initial record or picture of the accident scene from the perspective of the entity, such as the vehicle 102, associated with the computing device 101 without interaction or integration of other additional accident information from other entities.

When the accident reporting system 100 is set in the singular mode and the first set of accident information has been generated, the accident reporting system 100 generates a record that describes the accident scene using the first set of accident information (412). The accident reporting system 100 may store the record within a block that is provided to the blockchain so that the record is placed on one or more distributed ledgers.

When the accident reporting system 100 is set in the collaborative mode, the accident reporting system 100 obtains a second set of accident information (414). This second set of accident information may be obtained from a different source, the computing device or other entity other than the first set of accident information. By obtaining accident information from multiple different sources, such as a different vehicle or from a nearby traffic infrastructure or signal, the accident reporting system 100 may corroborate and/or integrate the multiple sources of accident information to depict a more accurate record of the accident. In an example, two or more vehicles may already be sharing information over a network, such as V2V, including sensor data for the vehicles in a continuous manner, including prior to and during the accident. Such shared information may be used to create one or more records of the accident. In some embodiments, the records of each vehicle may be compared to verify accuracy of each vehicle's record. The accident reporting system 100 may obtain the second set of accident information from a different vehicle, for example. The communication device 314 of the vehicle 102 may establish a communication channel with the communication device of the other vehicle and obtain the second set of accident information using V2V communication, for example. The second set of accident information may include the speed, the direction of travel, the rate of acceleration or deceleration, the relative speed and/or direction of travel of the vehicle 102 and/or other factors related to the other vehicle along with any of the different types of information, such as the sensor information, the weather information, the road condition information and/or the traffic information collected by the computing device of the other entity.

In some implementations, the accident reporting system 100 may obtain the second set of accident information from the traffic infrastructure, such as the traffic signal. The second set of accident information may include image data of the vehicle 102 and/or the surrounding vehicles and may include a state of one or more traffic signals, before, during and/or after the accident.

After the accident reporting system 100 obtains the second set of accident information, the accident reporting system 100 may, similarly, obtain a third set of accident information from another source, such as from another vehicle (416). The accident reporting system 100 may use the third set of accident information to resolve any differences between the first set of accident information and the second set of accident information.

The accident reporting system 100 integrates the different sets of accident information into a single record (418). The accident reporting system 100 may compare the two sets of accident information and form a set of accident information to record on the one or more distributed ledgers. The accident reporting system 100 may compare the two sets of information and determine which specific aspects or attributes of the information between the two sets substantially match and add the matched information onto the record. If the specific aspects or attributes of the information do not match, the accident reporting system 100 may compare the two sets of information with the third set of accident information and resolve the differences between specific aspects or attributes based on the specific aspects or attributes included in the third set of accident information. The accident reporting system 100 may use a rule, such as a majority or a plurality rules, to resolve the differences between the different sets of information, for example. In another example, the accident reporting system 100 may give more weight to one set of information over another based on factors, such as proximity of the accident to the vehicle 102, angle of viewing, clarity of the video, source of the information, recent servicing or verification of the vehicle, etc.

The accident reporting system 100 generates the record using the combined and/or integrated sets of accident information (420). The accident reporting system 100 associates the record with an identifier of the entity, a hash value and/or a timestamp (422). The identifier may be a vehicle identification number (VIN) of the vehicle 102, for example. Other identifiers may include a phone number or a business name for one or more of the service provider entities 108, one or more public entities 104 and/or one or more private reporting entities 106. Other identifiers may include license plate number, insurance policy number, or another assigned anonymous identifier. The identifier identifies the entity and/or the computing device of the entity that created or generated the record and provides a link between all the records on the one or more distributed ledgers created or generated by the entity. In some implementations, the identifier associated with the record identifies the accident scene or location. For example, an identifier of the accident scene may be a time stamp, a location stamp, and/or VINs of the one or more vehicles involved in the accident. Thus, other records associated with the accident scene may use the same identifier to link various records associated with the accident. Different records within the one or more distributed ledgers may be related to different accidents, and thus, the different accidents each may have their own identifier that links the different records within the one or more distributed ledgers. The record may be associated with multiple identifiers, such as the entity identifier that identifies the entity that created the record and/or the accident identifier that identifies the specific accident.

The accident reporting system 100 may generate a hash value to validate the underlying information within the record. For example, the accident reporting system 100 may generate the hash value using the identifier, such as the vehicle identification number, which validates that the record was created or generated from a specific entity, such as the vehicle 102. The identifier and hash value may be stored within the record prior to adding the record to the distributed ledger.

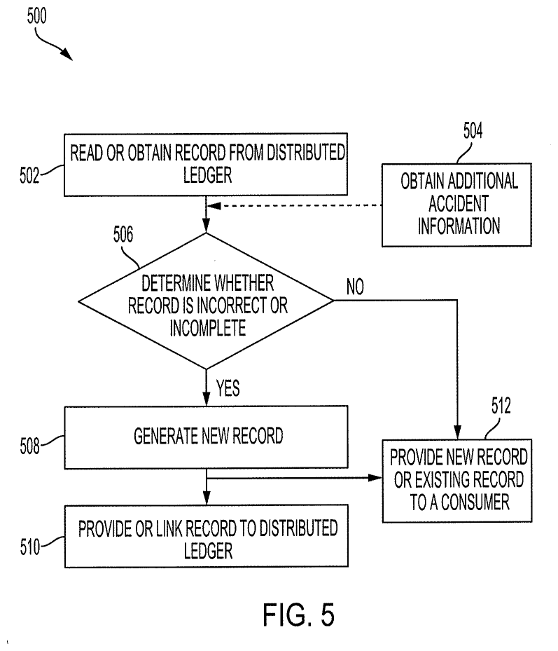

The accident reporting system 100 links, adds or provides the record of the accident information to the distributed ledger (424). The accident reporting system 100 may link the block associated with the record onto the blockchain that is associated with the distributed ledger to add to the record. This allows the other entities to view, verify and authenticate the record on the distributed ledger in real-time. Moreover, the record may not be removed from the distributed ledger, rather, another entity may modify the record by appending an amended record to the distributed ledger. The other entities may act on the record once the record is added to the distributed ledger. FIG. 5 describes different actions other entities may perform in response to the provided record.

FIG. 5 is a flow diagram of a process 500 for viewing and/or executing a task within a record of one or more distributed ledgers. One or more computers or data processing apparatuses, for example, the computing devices 101, 103, 105, 107, 109, 110 of the accident reporting system 100 of FIG. 1, appropriately programmed, may implement and execute the process 500.

The accident reporting system 100 obtains a record from the distributed ledger (504). The accident reporting system 100 may read, view or otherwise obtain the record from the distributed ledger by reading the block associated with the record on the blockchain. In some implementations, the computing device 101, 103, 105, 107, 109, 110 may request permission to read or view the block associated with the record. The computing device 101, 103, 105, 107, 109, 110 associated with the entity that created or generated the record may have associated the record with a list of entities that may be granted viewing privileges. If the entity associated with the computing device 101, 103, 105, 107, 109, 110 that requests permission is on the list of entities, the computing device 101, 103, 105, 107, 109, 110 may view, read or obtain the record.

The accident reporting system 100 may obtain additional accident information, before, during or after viewing the record (504). The accident reporting system 100 may obtain the additional accident information from a different entity than the entity associated with creating or generating the record on the distributed ledger. The computing device 101, 103, 105, 107, 109, 110 may add the additional accident information via user input and store the additional accident information within a memory of the computing device of the entity. The additional accident information may elaborate on the accident information stored on the record.

For example, the vehicle 102 may have generated the record and one or more public entities 104, such as an officer, may elaborate on the accident information with other observations, such as witness accounts, photographs of the accident scene, and/or driver statements using the associated computing device 103. In another example, the hospital may provide user input to an associated computing device 103 that describes what the injured person says or elaborates on the extent of the injuries after one or more injured persons from the accident has arrived from the accident scene. In another example, one or more service provider entities 108 may provide user input to an associated computing device 107 that elaborates on the extent of the damage to the vehicle 102.

The accident reporting system 100 determines whether the record is incorrect or incomplete (506). The accident reporting system 100 may automatically determine that the record is incorrect or incomplete if additional accident information has been previously-provided or entered in a computing device 101, 103, 105, 107, 109, 110 associated with the viewing entity. In some implementations, the accident reporting system 100 may display the record for viewing on the computing device 101, 103, 105, 107, 109, 110 and request user input from the entity to confirm that the record is complete and accurate.

If the user input indicates that the record is complete and accurate and/or there is no additional information stored in the memory 206 of the associated computing device 101, 103, 105, 107, 109, 110, the accident reporting system 100 may provide the existing record to an entity without access to the one or more distributed ledgers, as described below (512). If the user input indicates that the record is incomplete or inaccurate and/or there is additional accident information stored in the memory 206, the accident reporting system 100 may proceed to generate a new record with the additional information (508). The new record may provide information, such as the parts to order or the services to schedule to repair the damage to the vehicle 102, the resources used to treat an injured person, the treatments performed to the injured persons, cost estimates for the damages to the vehicle, witness accounts or other accident scene information.

For example, the public entity 104 may generate a new record with the observations of the police officer, witness accounts or other additional information gathered by the police officer at the accident scene. The computing device 103 may associate the new record with the public entity 104 that generated the new record and the accident scene using one or more identifiers, e.g., a phone number of the public entity 104 and/or an accident scene identifier, such as the time stamp and location of the accident.

Once the new record has been generated, the accident reporting system 100 provides or links the new record to the distributed ledger (510). The accident reporting system 100 may append a block that is associated with the new record to the blockchain that represents the distributed ledger.

In some implementations, after the new record has been generated or if the existing record is not incomplete and/or inaccurate, the accident reporting system 100 may report or provide the new record to a consumer to order parts, provide services and/or as an official report to an entity without access to the one or more distributed ledgers (512). For example, the new record may be a police report that is provided to a claims adjuster to resolve pending auto, health or life claims. In another example, the new record may indicate the parts and/or services necessary to repair one or more vehicles involved in the accident and may order the parts and/or services from a manufacturer or other entity that does not have access to the one or more distributed ledgers. In another example, the existing record may indicate the damage to the vehicle 102 and the consumer may determine the parts and/or services necessary to repair the vehicle 102. In another example, the existing record may indicate a location of the accident and the damage to the vehicle, and a tow service company may deploy a tow truck based on the information in the record.

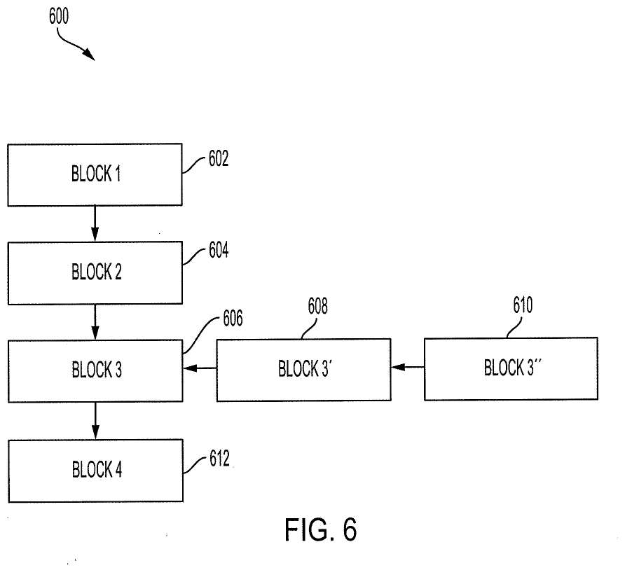

FIG. 6 shows a distributed ledger represented as a blockchain 600 and corresponding records on the distributed ledger represented as blocks 602, 604, 606, 608, 610, 612 on the blockchain. The blocks 602, 604, 606, 608, 610, 612 each represents different records that are linked on the blockchain 600. The blocks 602, 604, 606, 608, 610, 612 may have been generated by different entities and/or the same entity. Each block is linked to another adjacent block. The blocks 608, 610 are linked to the block 606 to represent modifications and/or updates to the linked block 606. That is, the information in the new record represented by block 608 modifies and/or updates the information within the record represented by the block 606 may be linked to the block 606 using an identifier, such as a VIN number of accident identifier. Similarly, the information within the record represented by the block 610 modifies and/or updates the information within the record represented by the blocks 606, 608.

Where used throughout the specification and the claims, “at least one of A or B” includes “A” only, “B” only, or “A and B.” Exemplary embodiments of the methods/systems have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. An accident logging and reporting system, comprising:
a plurality of computing devices including a first computing device integrated on a first vehicle and a second computing device, each computing device of the plurality of computing devices being configured to maintain a distributed ledger;
wherein the first computing device includes:
one or more sensors configured to detect, measure or obtain sensor information related to an accident;
a communication unit configured to communicate with the second computing device; and
an electronic control unit coupled to the one or more sensors and the communication unit and configured to:
integrate a first set of accident information with a second set of accident information generated by the second computing device including comparing each parameter of the first set of accident information with a corresponding parameter of the second set of accident information and a third set of accident information, and
link a record that represents a combined set of accident information that incorporates the integrated first set and second set of accident information to the distributed ledger.

2. The accident logging and reporting system of claim 1, wherein the distributed ledger is represented by a blockchain that is formed from a plurality of blocks and the record is associated with a block.

3. The accident logging and reporting system of claim 1, wherein to integrate the first set of accident information with the second set of accident information the electronic control unit is configured to:
obtain the third set of accident information, and
determine whether the parameter of the first set of accident information matches the corresponding parameter of the second set of accident information or the third set of accident information.

4. The accident logging and reporting system of claim 3, wherein the electronic control unit is configured to:
form the combined set of accident information from the parameters that match among the first set of accident information, the second set of accident information and the third set of accident information.

5. The accident logging and reporting system of claim 1, wherein the one or more sensors include a vehicle speed sensor, an impact sensor, proximity sensor or a camera, wherein the impact sensor is configured to detect a collision, the vehicle speed sensor is configured to measure a speed of the first vehicle and the camera is configured to capture image data.

6. The accident logging and reporting system of claim 1, wherein the second computing device is a traffic database or traffic infrastructure that is configured to provide traffic information including a state of one or more traffic signals, wherein the second set of accident information includes a state of the one or more traffic signals that indicate a right of way of traffic.

7. The accident logging and reporting system of claim 1, wherein the electronic control unit is configured to:
associate the record with a vehicle identification number and an accident scene identifier, wherein the accident scene identifier includes a timestamp of a time of the accident and a location of the accident.

8. The accident logging and reporting system of claim 7, wherein the one or more sensors include a battery sensor, wherein the electronic control unit is configured to:
determine, using the battery sensor, that a battery is damaged;
include information that indicates that the battery is damaged in the first set of information; and
associate the combined set of accident information with a vehicle identification number of the first vehicle.

9. The accident logging and reporting system of claim 8, wherein the second computing device is associated with a repair service provider and includes:
a processor that is configured to:
read or obtain the record based on at least one of the accident scene identifier or the vehicle identification number,
determine that the record is incomplete or inaccurate,
associate a new record that has additional accident information with the accident scene identifier, and
provide the new record to a consumer or link the new record to the distributed ledger using the accident scene identifier.

10. A method for accident logging and reporting, comprising:
detecting, by a first sensor of a first vehicle, that a collision has occurred to the first vehicle;
generating, by a processor of the first vehicle, a first set of accident information related to the collision of the first vehicle;
coordinating, by the processor of the first vehicle, the first set of accident information with a second set of accident information; and
linking, by the processor of the first vehicle, a block that represents a combined set of accident information that is based on the first set of accident information and the second set of accident information to a plurality of blocks of a distributed ledger.

11. The method of claim 10, further comprising:
determining, by a second sensor of the first vehicle, that a battery of the first vehicle is damaged, wherein the first set of accident information include an indication that the battery of the first vehicle is damaged;
reviewing, by a second processor, the block that represents the combined set of accident information; and
providing, by the second processor, repair information to repair the battery of the first vehicle.

12. The method of claim 11, further comprising:
linking, by the second processor, a second block associated with the repair information to the plurality of blocks of the distributed ledger.

13. The method of claim 10, further comprising:
detecting, by a second sensor, at least one of a speed of the first vehicle, a relative direction of a second vehicle or a relative speed of the second vehicle, wherein generating the first set of accident information related to the collision of the first vehicle is based on the at least one of the speed of the first vehicle, the relative direction of the second vehicle or the relative speed of the second vehicle.

14. The method of claim 10, further comprising:
providing a second set of accident information that includes a state of the one or more traffic signals to the processor of the first vehicle.

15. The method of claim 10, wherein coordinating the first set of accident information with the second set of accident information includes comparing each parameter of the first set of accident information with a corresponding parameter of the second set of accident information and a corresponding parameter of a third set of accident information; and
determining whether the parameter of the first set of accident information matches the corresponding parameter of the second set of accident information or the third set of accident information.

16. The method of claim 15, further comprising:
determining that the parameter of the first set of accident information matches the corresponding parameter of the second set of accident information or the third set of accident information; and
forming the combined set of accident information from the parameters that match among the first set of accident information, the second set of accident information and the third set of accident information.

17. A system, comprising:
a plurality of computing devices including a first computing device integrated on a first vehicle and a second computing device, each computing device of the plurality of computing devices being configured to maintain a distributed ledger formed from a plurality of blocks;
wherein the first computing device includes:
a first sensor configured to detect a collision of the first vehicle; and
an electronic control unit coupled to the first sensor and configured to:
obtain a first set of accident information when the first sensor detects a collision,
integrate the first set of accident information with a second set of accident information generated by the second computing device, and
link a block that represents a combined set of accident information that incorporates the integrated first set and second set of accident information to the plurality of blocks that form the distributed ledger.

18. The system of claim 17, wherein the electronic control unit is configured to:
associate the block with a vehicle identification number of the first vehicle prior to linking the block to the plurality of blocks.

19. The system of claim 17, wherein the second computing device includes a processor, wherein the processor of the second computing device is configured to:
link a second block that represents a third set of accident information that modifies or adds additional accident information to the accident information of the block that represents the combined set of accident information.

20. The system of claim 17, wherein the second computing device is a traffic database or traffic infrastructure that is configured to provide traffic information including one or more states of one or more traffic signals, wherein the second set of accident information includes a state of the one or more traffic signals that indicate a right of way of traffic.
